(19) United States
(12) Patent Application Publication
(10) Pub. No.: US 2025/0391284 A1
(43) Pub. Date: Dec. 25, 2025

(54) INFORMATION PROCESSING APPARATUS AND METHOD OF CONTROLLING THE SAME, AND STORAGE MEDIUM

(71) Applicant: CANON KABUSHIKI KAISHA, Tokyo (JP)

(72) Inventor: NAOKI MARUYAMA, Tokyo (JP)

(21) Appl. No.: 19/234,438

(22) Filed: Jun. 11, 2025

(30) Foreign Application Priority Data
Jun. 24, 2024 (JP) 2024-101420

(51) Int. Cl. G09B 7/00; H04N 1/00; H04N 1/04

(52) U.S. Cl. CPC G09B 7/00; H04N 1/00798; H04N 1/04; H04N 2201/0094

(57) ABSTRACT

An information processing apparatus determines whether cooperative setting for cooperation with a digital service is completed when processing that can cooperate with the digital service is executed, and in a case that it is determined that cooperation with the digital service is not completed, determines whether setting information for the cooperation issued from the digital service is held. In a case that it is determined that the setting information for the cooperation is not held, the information apparatus displays a first screen for performing setting of cooperation with the digital service and setting of the processing that can cooperate with the digital service in the information processing apparatus, and in a case that it is determined that the setting information for cooperation is held, the information apparatus displays a second screen for performing setting of the processing that can cooperate with the digital service in the information processing apparatus.

### BACKGROUND

### Field of the Technology

The present disclosure relates to an information processing apparatus and a method of controlling the same, and a storage medium.

### Description of the Related Art

The recent Global and Innovation Gateway for All (GIGA) School Program recommends efficiency improvement of school affairs using digital services. By this, various services have appeared, and introduction to educational sites has also progressed. From such a background, a plurality of services such as a learning management system (hereinafter, called LMS), a questionnaire processing system, and a digital grading application (hereinafter, called a grading app) are used depending on the purpose. However, since it is necessary to perform login for each of the plurality of services, there is a problem that it is inconvenient for a user who wants to use these services.

Such a situation similarly occurs in places other than education sites, and for example, Japanese Patent Laid-Open No. 2018-156405 describes a technique for solving the above problem by executing user registration and cooperative processing in series using a general authentication and authorization mechanism such as OAuth or OpenID Connect.

In the case of the technique described in Japanese Patent Laid-Open No. 2018-156405, after user registration is performed on a target service, authorization processing is performed in a series of flows. At this time, it is assumed that after the authorization processing is performed halfway, the authorization processing is interrupted and forgotten. Thereafter, if processing requiring user registration and authorization is executed, a cooperative screen with the service is not displayed, and an error occurs. In such a situation, it is impossible to present the user with appropriate guidance according to the registration situation of the user or the like, which is inconvenient.

### SUMMARY

Embodiments of the present disclosure eliminate the above-mentioned issues with conventional technology.

A feature of embodiments of the present disclosure is to provide a technique of performing display for guiding to an unimplemented setting for cooperation when cooperation with a digital service is required and setting for cooperation is not completed.

According to embodiments of the present disclosure, there is provided an information processing apparatus comprising: one or more controllers including one or more processors and one or more memories, the one or more controllers configured to: determine whether cooperative setting for cooperation with a digital service is completed when processing that can cooperate with the digital service is executed; in a case that it is determined that cooperation with the digital service is not completed, determine whether setting information for the cooperation issued from the digital service is held; in a case that it is determined that the setting information for the cooperation is not held, display a first screen for performing setting of cooperation with the digital service and setting of the processing that can cooperate with the digital service in the information processing apparatus; and in a case that it is determined that the setting information for cooperation is held, display a second screen for performing setting of the processing that can cooperate with the digital service in the information processing apparatus.

According to embodiments of the present disclosure, there is provided a method of controlling an information processing apparatus, comprising: determining whether cooperative setting for cooperation with a digital service is completed when processing that can cooperate with the digital service is executed; in a case that it is determined that cooperation with the digital service is not completed, determining whether setting information for cooperation with the digital service issued from the digital service is held; in a case that it is determined that the setting information for cooperation with the digital service is not held, displaying a first screen for performing setting of cooperation with the digital service and setting of the processing in the information processing apparatus; and in a case that that the setting information for cooperation with the digital service is held, displaying a second screen for performing setting of the processing in the information processing apparatus.

Further features of the various embodiments will become apparent from the following description of exemplary embodiments with reference to the attached drawings. The following descriptions of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a system according to an embodiment and a hardware configuration of a multi-function peripheral and an information device included in the system.

FIGS. 2A to 2H depict views illustrating examples of screens displayed on an operation unit of the multi-function peripheral according to the embodiment.

FIGS. 3A to 3H depict views illustrating examples of screens displayed on an operation unit of the information device according to the embodiment.

FIGS. 4A and 4B depicts views illustrating examples of screens displayed by the information device according to the embodiment.

FIG. 5 is a flowchart for describing processing when the multi-function peripheral according to the present embodiment executes scan processing for an answer sheet.

FIG. 6 is a flowchart for describing processing of performing cooperative wizard LMS side setting display by the information device according to the embodiment.

FIG. 7 is a flowchart for describing processing of performing setting display on a cooperative wizard grading app side by the information device according to the embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted. Note that in the following description, an image forming apparatus is also called a multi-function peripheral (MFP) in some cases.

In the present embodiment, an example in which a multi-function peripheral (MFP) 100 is used as a system will be described.

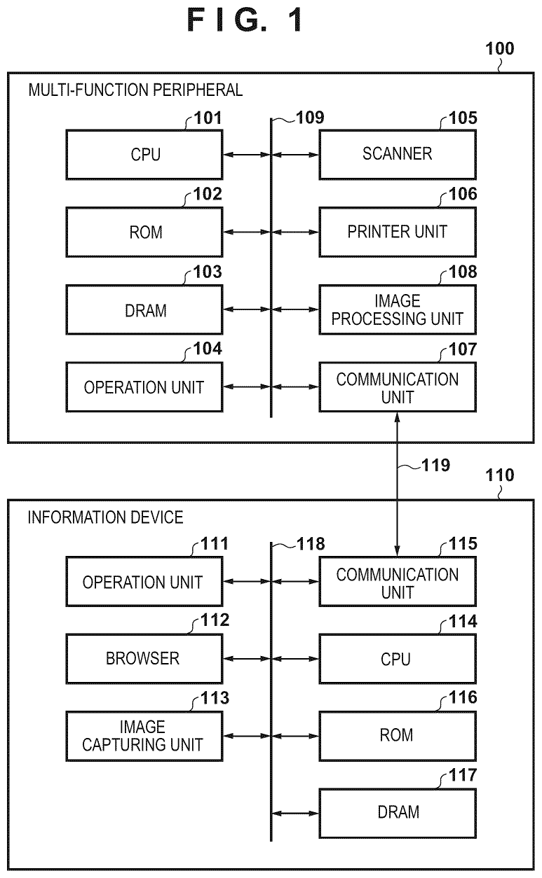

FIG. 1 is a block diagram for describing a system according to an embodiment and a hardware configuration of the multi-function peripheral 100 and an information device 110 included in the system.

In the present embodiment, the multi-function peripheral (MFP) 100 functions as an information processing apparatus and provides an education-related grading app as an application program, for example, and the information device 110 executes a learning management system (LMS). The information device 110 is, for example, an information terminal having a browser such as a PC, and performs cooperative processing by accessing a remote user interface (RUI) of the multi-function peripheral 100 with the browser of this information device 110 and displaying a cooperative wizard. It is assumed that setting information necessary for setting (hereinafter, cooperative setting) for the cooperative processing is confirmed by operating a web page of the LMS in another tab or window of the browser of the information device 110. An example in which, for example, an answer sheet is scanned and read by the multi-function peripheral 100, and based on it, the information device 110 executes grading and aggregating of the answer sheet will be described. At this time, the multi-function peripheral 100 and the LMS need to be set in advance for LMS cooperation. In order to perform this LMS cooperation, authentication and authorization based on Learning Tools Interoperability (hereinafter LTI), which is an international cooperation standard, are required, and thus cooperation between the grading app and the LMS needs to be performed in advance. In the setting of the cooperation between the grading app and the LMS, it is necessary to perform the cooperative setting on each of the multi-function peripheral 100 side and the information device 110 side.

First, the configuration of the multi-function peripheral 100 will be described.

A CPU 101 functions as a control unit that controls the multi-function peripheral 100, and controls the entire operation of the multi-function peripheral 100 by deploying a control program stored in a ROM 102 into a DRAM 103 and executing the control program. The ROM 102 includes a flash memory such as an eMMC, for example, and stores various data such as a control program of the CPU 101 and image data. The DRAM 103 functions as a working memory that stores various data at the time of execution of processing by the CPU 101, and is a volatile memory that can temporarily save program control variables and the like, image data to be processed, and the like. An operation unit 104 is an interface unit with the user that displays information in the device to the user and receives an operation of the user. A scanner 105 converts image data obtained by reading a document into, for example, binary data. The scanner 105 implements a document reading function in this multi-function peripheral 100. A printer unit 106 performs, for example, fixing temperature adjustment control to fix an image on a printing sheet (printing medium) and print the image. A communication unit 107 is an interface unit between the multi-function peripheral 100 and an external communication network. The communication unit 107 includes a network communication unit, which is an interface to the network, and a USB flash memory control unit that performs input and output to and from a USB flash memory. An image processing unit 108 includes, for example, an ASIC that performs image processing such as resolution conversion, compression/expansion, and rotation on input and output image data. The above-described units are connected via a bus 109.

Next, the configuration of the information device 110 will be described. This information device 110 is a device for displaying the cooperative wizard and performing cooperative setting between the grading app and the LMS.

An operation unit 111 is an interface unit with the user that displays information on the information device 110, and also plays a role of receiving an input from the user depending on the configuration of the information device 110. A browser 112 interprets, for example, html, script, and the like and presents it to the user. Use of the browser 112 enables data such as text and images to be browsed and edited. An image capturing unit 113 includes an image sensor that can shoot a video around the user such as a moving image or a still image. A CPU 114 functions as a control unit of the information device 110 and controls the entire information device 110. It is also possible to extract information by analyzing a two-dimensional code obtained from the image capturing unit 113 using this CPU 114. A communication unit 115 is an interface unit between the information device 110 and the external communication network, and includes a network communication unit, which is an interface to the network and a USB flash memory control unit that performs input/output to/from the USB flash memory. A ROM 116 includes a flash memory such as an eMMC, for example, and stores a control program of the CPU 114, image data, and the like. A DRAM 117 functions as a working memory that stores various data at the time of execution of processing by the CPU 114, and is a volatile memory that can temporarily save program control variables and the like, image data to be processed, and the like. Each control unit and module is connected via a bus 118. In this system, the multi-function peripheral 100 and the information device 110 are connected via a network 119. This enables the user to access the multi-function peripheral 100 from the own information device 110 and confirm and set various types of information.

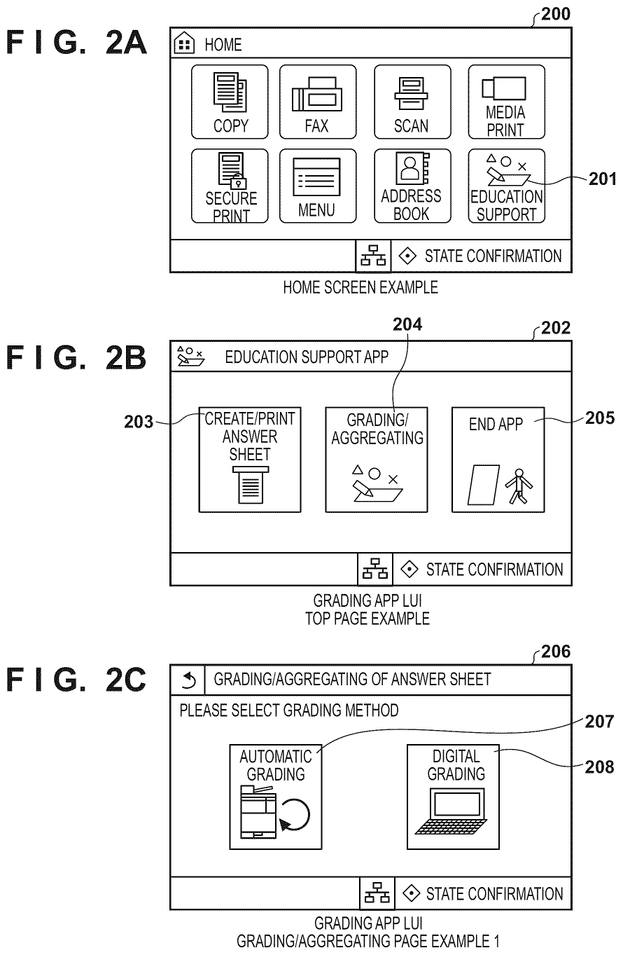

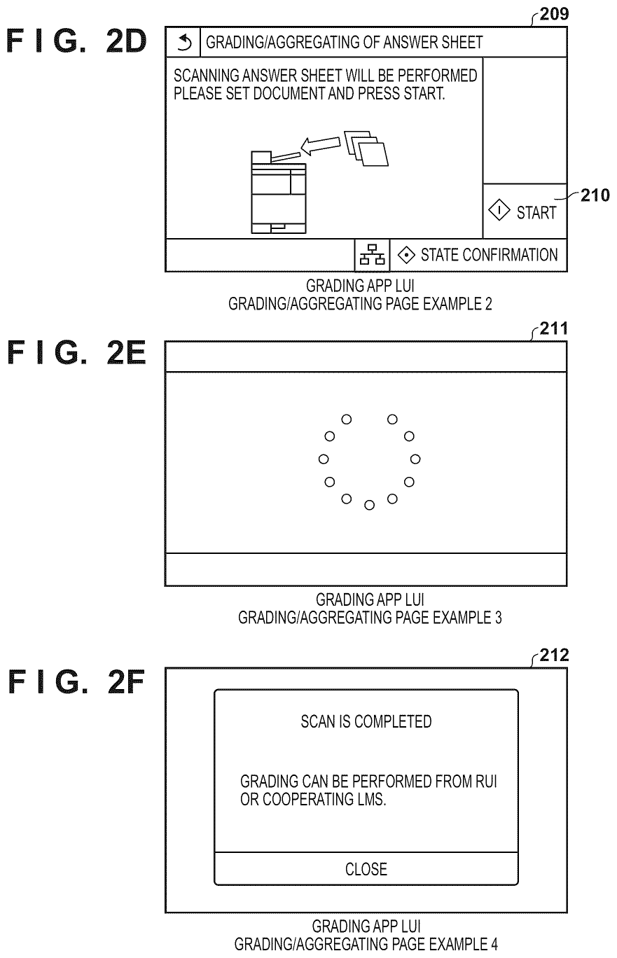

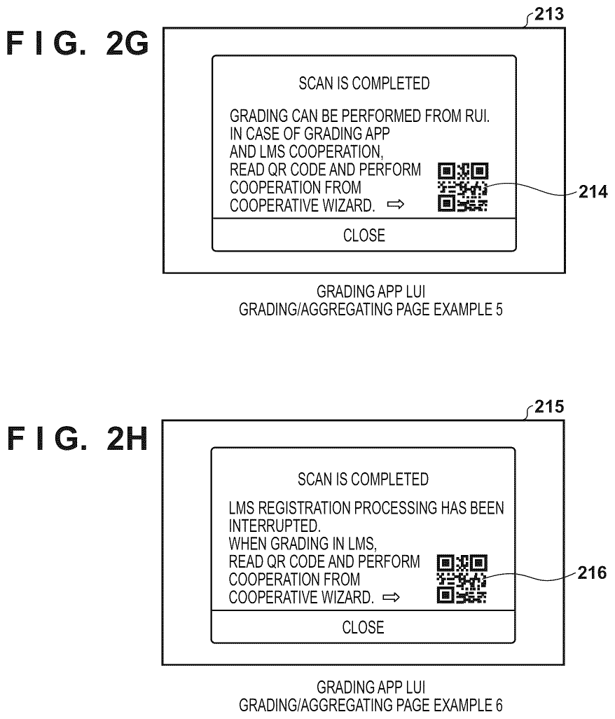

FIGS. 2A to 2H depict views illustrating examples of screens displayed on the operation unit 104 of the multi-function peripheral 100 according to the embodiment. The display control of these screens is implemented by the CPU 101 executing a program deployed into the DRAM 103.

A home screen 200 in FIG. 2A shows an example of a home screen displayed on the operation unit 104 of the multi-function peripheral 100. This home screen 200 is mainly displayed on the operation unit 104 immediately after the multi-function peripheral 100 is started, and the user can display a screen registered in an icon by tapping the icon displayed on this screen. For example, by tapping an education support icon 201, it is possible to display a screen (FIG. 2B) for performing an operation related to an education support app.

A screen 202 of a digital grading app Local User Interface (LUI) top page example in FIG. 2B illustrates an example of a screen immediately after the grading support app is started, which is displayed on the operation unit 104 of the multi-function peripheral 100.

This screen 202 includes a “create/print answer sheet” button 203, a “grade/aggregate” button 204, and an “end app” button 205 for ending the application. When the “create/print answer sheet” button 203 is pressed, creation and print of an answer sheet can be instructed using the operation unit 104. Note that the function and the screen operated by pressing this button 203 are not features of the present embodiment, and thus detailed description thereof will be omitted. When the “grade/aggregate” button 204 is pressed, a digital grading app for scanning and grading the answer sheets that have been answered is started. When the digital grading app is started, the screen transitions to a screen 206 (FIG. 2C) of a digital grading app LUI grading/aggregating page example 1. When the “end app” button 205 is pressed, this application is finished. Note that LUI is an abbreviation for Local User Interface, and hereinafter, is abbreviated as LUI.

The screen 206 of the digital grading app LUI grading/aggregating page example 1 in FIG. 2C illustrates an example of a screen for selecting a grading method displayed on the operation unit 104 of the multi-function peripheral 100. When an automatic grading button 207 is pressed, an image scanned by the scanner 105 is automatically graded and aggregation processing is performed. Note that the function and the screen operated by pressing the automatic grading button 207 are not features of the present embodiment, and thus detailed description thereof will be omitted. When a digital grading button 208 is pressed, the screen transitions to a screen 209 of a digital grading app LUI grading/aggregating page example 2 in FIG. 2D for reading a test of a digital grading target.

The screen 209 of the digital grading app LUI grading/aggregating page example 2 in FIG. 2D illustrates an example of a screen for scanning a test answer sheet of the digital grading target displayed on the operation unit 104 of the multi-function peripheral 100. When a start button 210 is pressed, scanning of the answer sheet by the scanner 105 is started.

A screen 211 of a digital grading app LUI grading/aggregating page example 3 in FIG. 2E shows an example of a screen displayed on the operation unit 104 of the multi-function peripheral 100 and indicating that the test answer sheet of the digital grading target is being scanned. This screen 211 is displayed until scanning by the scanner 105 is completed. When the scan is completed, the screen automatically transitions to a screen 212 of a digital grading app LUI grading/aggregating page example 4 in FIG. 2F.

The screen 212 of the digital grading app LUI grading/aggregating page example 4 in FIG. 2F shows an example of a screen displayed on the operation unit 104 of the multi-function peripheral 100 and indicating that scanning of the test answer sheet of the digital grading target is completed. In the example of FIG. 2F, since the grading app and the LMS are cooperating, a message “Grading can be performed from the RUI or the cooperating LMS” is displayed. In this manner, the screen 212 can notify the user that grading can be performed from the RUI or the cooperating LMS. When the scanning is completed, this screen 212 is automatically displayed, and a close button is pressed, the screen transitions to the screen 202 of the digital grading app LUI top page example in FIG. 2B.

A screen 213 of a digital grading app LUI grading/aggregating page example 5 in FIG. 2G shows an example of a screen displayed on the operation unit 104 of the multi-function peripheral 100 and indicating that scanning of the test answer sheet of the digital grading target is completed. Unlike the screen 212 of the digital grading app LUI grading/aggregating page example 4 in FIG. 2F, this screen 213 is a screen displayed when the grading app and the LMS are not cooperating. A page for executing a cooperative wizard with the LMS can be accessed from a two-dimensional code 214. Note that the page for executing the cooperative wizard will be described later. When the close button is pressed on this screen 213, the screen transitions to the screen 202 of the digital grading app LUI top page example in FIG. 2B.

A screen 215 of a digital grading app LUI grading/aggregating page example 6 in FIG. 2H shows an example of a screen displayed on the operation unit 104 of the multi-function peripheral 100 and indicating that scanning of the test answer sheet of the digital grading target is completed. Unlike the screen 213 of the digital grading app LUI grading/aggregating page example 5 in FIG. 2G, this screen 215 is displayed when the cooperation between the grading app and the LMS is performed halfway and in an interrupted state. Also in this case, the page for executing a cooperative wizard with the LMS can be accessed from a two-dimensional code 216, and the remaining setting of the interrupted cooperation work can be performed. Note that the page for executing the cooperative wizard will be described later. When the close button is pressed also on this screen 215, the screen transitions to the screen 202 of the digital grading app LUI top page example in FIG. 2B.

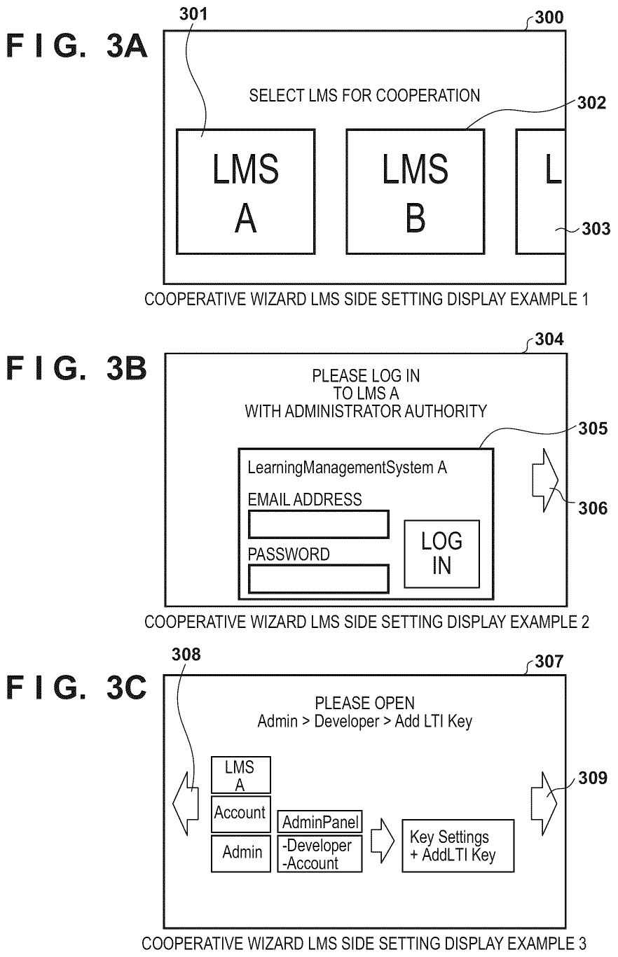

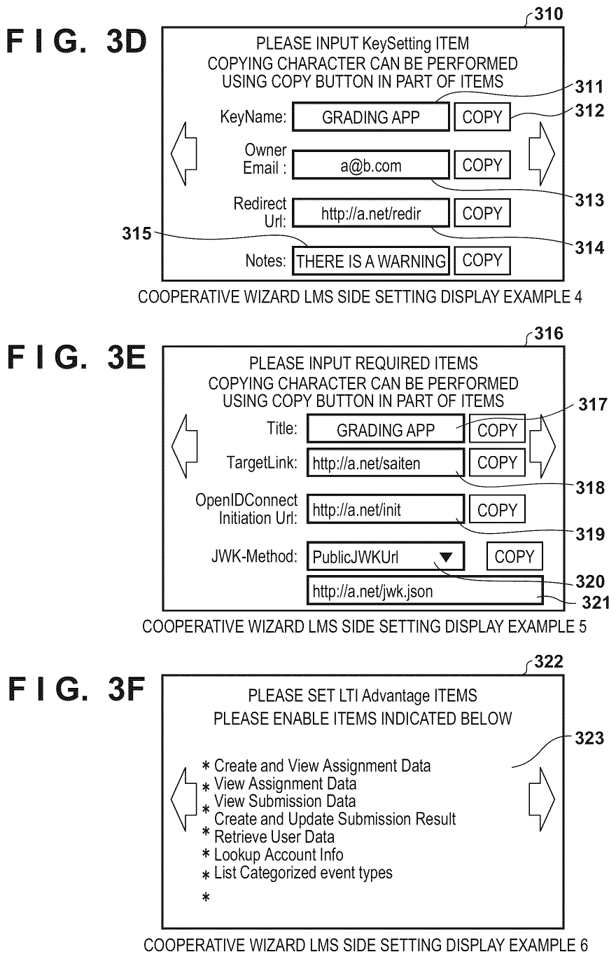

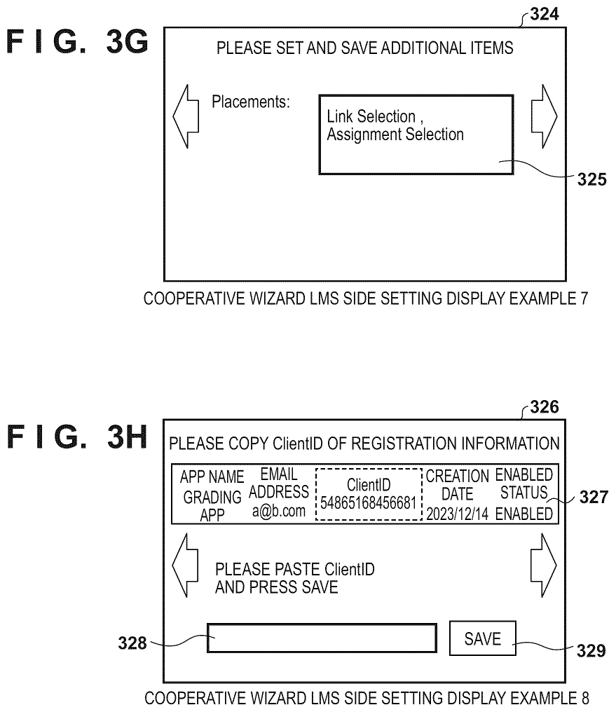

FIGS. 3A to 3H depict views illustrating examples of screens displayed on the operation unit 111 of the information device 110 according to the embodiment.

A screen 300 of a cooperative wizard LMS side setting display example 1 in FIG. 3A shows an example of a screen of a wizard for cooperating the grading app and the LMS, displayed by accessing the multi-function peripheral 100 via the communication unit 115 by the browser 112 of the information device 110. It is also possible to shoot and access the two-dimensional code 214 displayed on the screen 213 of the digital grading app LUI grading/aggregating page example 5 in FIG. 2G by the image capturing unit 113 of the information device 110. This screen 300 displays a plurality of LMS icons 301 to 303, and it is possible to start cooperative setting for cooperation with a corresponding LMS by selecting any of the icons. Note that in the embodiment, a known authentication and authorization flow called Learning Tools Interoperability (hereinafter LTI) is used as a mechanism for cooperating the LMS and the grading app. Since the LTI authentication and authorization flow conforms to a known authentication and authorization mechanism called an implicit flow of OpenID Connect, information essential in the flow is set.

A screen 304 of a cooperative wizard LMS side setting display example 2 in FIG. 3B illustrates an example of a screen of a cooperative wizard displayed when an LMS A301 is selected on the screen 300 of the cooperative wizard LMS side setting display example 1 in FIG. 3A. An upper part of this screen 304 presents work content to be requested for the user to execute, and a screen central part 305 displays a screen image of the LMS of a work target. The screen 304 in FIG. 3B requests the user to log in to a target LMS with administrator authority, and the screen central part 305 displays a login screen of a cooperation target. Here, when the user performs login work by entering an email address and a password, the screen transitions to the next screen by pressing a forward button 306 displayed on the right side of the screen 304.

A screen 307 of a cooperative wizard LMS side setting display example 3 in FIG. 3C shows an example of a screen of a cooperative wizard transitioned by pressing the forward button 306 on the screen 304 of the cooperative wizard LMS side setting display example 2 in FIG. 3B. This screen 307 displays guidance for issuing LTI information for LMS cooperation to the user. Note that this screen 307 merely illustrates a screen display image of a part of the LMS, and it is assumed that a dedicated screen is prepared for each LMS. On this screen 307, when a back button 308 is pressed, the screen can return to the previous screen, and when a forward button 309 is pressed, the screen transitions to the next screen. Since these buttons 308 and 309 are displayed on each screen of the cooperative wizard, the description thereof will be omitted hereinafter.

A screen 310 of a cooperative wizard LMS side setting display example 4 in FIG. 3D shows an example of a screen of a cooperative wizard transitioning next to the screen 307 of the cooperative wizard LMS side setting display example 3 in FIG. 3C. This screen 310 displays input guidance of an item for issuing LTI information for LMS cooperation to the user. The user inputs an item on a management screen of a cooperation target LMS with reference to the display of this screen 310.

First, the user performs setting with reference to a name sample 311 of a cooperation LTI key issued by the LMS. This name sample 311 is information merely for managing a key in the LMS, is a parameter not involved in authentication in the LTI, and is not essential. Note that when a COPY button 312 is pressed, the sample information can be copied to a clipboard and can be pasted to a management page of the LMS. Next, the user performs setting with reference to an administrator email address sample 313 of the LTI key. Note that in the sample 313, an email address of an administrator registered in advance in the multi-function peripheral 100 by the user is written. This email address information is also a parameter used for management in the LMS and is a parameter not involved in authentication of the LTI, and thus is not essential. A redirect URL sample 314 means a URL for starting a grading app provided by the multi-function peripheral 100. That is, it is a URL for displaying a page of the grading app displayed after the authentication by the LTI is completed. A parameter of this redirect URL sample 314 is a parameter essential for performing the mechanism of LTI authentication. Note that the URL of the grading app is preset in this redirect URL sample 314. A note 315 is information displayed as note information on an LTI key management screen. The parameter of this note 315 is a parameter used in the management page in the LMS, and is not essential in performing the mechanism of LTI authentication.

A screen 316 of a cooperative wizard LMS side setting display example 5 in FIG. 3E illustrates an example of a screen of a cooperative wizard transitioning next to the screen 310 of the cooperative wizard LMS side setting display example 4 in FIG. 3D. This screen 316 continues to display item input guidance for issuing LTI information for LMS cooperation. The user inputs an item on a management screen of a cooperation target LMS with reference to the display of this screen 316. As a name of a target app with which the LMS cooperates, a grading app name 317 is input as a sample. Similarly to the name sample 311 in FIG. 3D, this grading app name 317 is a parameter used in the management page of the LMS, and is not essential in performing LTI authentication. The URL for starting the grading app provided by the multi-function peripheral 100 that is same as the redirect URL sample 314 is input to a target link 318. An OpenID Connect Initiation Url 319 is a URL for making a login request from the LMS to the grading app. A login request is transmitted from the LMS to this URL, and authentication authorization is started from there by an implicit flow of OpenID Connect, and thus it is an essential parameter. In this OpenID Connect Initiation Url 319, a URL obtained in advance from the grading app is input. In an authentication method 320, a method of providing a public key for an authentication request verification to be provided to the LMS is selected. Typical examples include Public JWK and Public JWK URL. JWK is an abbreviation for JSON Web Key, and refers to encryption key data in a JSON data format. Public JWK designate an encryption key in a public JSON data format, that is, a public key. This Public JWK and JSON Web Key designate to an encryption key called a known public key, and a detailed description thereof will be omitted. As authentication information 321, public key information corresponding to an item selected by the authentication method 320 is input. For example, in a case of Public JWK URL, a URL for providing Public JWK is input. Note that the authentication method 320 and the authentication information 321 are both essential setting items.

A screen 322 of a cooperative wizard LMS side setting display example 6 in FIG. 3F shows an example of a screen of a cooperative wizard transitioning next to the screen 316 of the cooperative wizard LMS side setting display example 5 in FIG. 3E. On this screen 322, an authority 323 to be given to LTI cooperative setting is set. That is, in reference and operation of grading data, whether to permit only reading, whether to permit both reading and writing, and the like are set.

A screen 324 of a cooperative wizard LMS side setting display example 7 in FIG. 3G shows an example of a screen of a cooperative wizard transitioning next to the screen 322 of the cooperative wizard LMS side setting display example 6 in FIG. 3F. On this screen 324, an LTI cooperative function necessary for LTI cooperation is set. In the LTI, after cooperation is performed using LTI Resource Link, which is an authentication and authorization flow for displaying a grading app screen on the LMS, data communication with the grading app is performed using various cooperative functions provided by the LTI. For example, enabling a cooperative function called Deep Linking makes it possible to access content data in the grading app from the LMS. Enabling a cooperative function called Assignment and Grade Services makes it possible to perform writing and reading of grade data from the LMS to the grading app and addition of grade data. Which of these cooperative functions is enabled is set on the screen 324. On this screen 324, as an example as shown in an area 325, Link Selection for enabling Deep Linking and Assignment Selection for enabling Assignment and Grade Services are set. Note that the item name is different for each LMS.

A screen 326 of a cooperative wizard LMS side setting display example 8 in FIG. 3H shows an example of a screen of a cooperative wizard transitioning next to the screen 324 of the cooperative wizard LMS side setting display example 7 in FIG. 3G. On this screen 326, ID information for cooperation to be set in the multi-function peripheral 100 is obtained and set in the multi-function peripheral 100. At this stage, registration information 327 is displayed on a management page on the LMS side, and the ID information for cooperation is obtained from this registration information 327, is input into a text box 328, and is set in the multi-function peripheral 100 by pressing a save button 329. Note that, in the case of LMS A illustrated as an example this time, a client ID is ID information for cooperation, and cooperation is performed using this ID information.

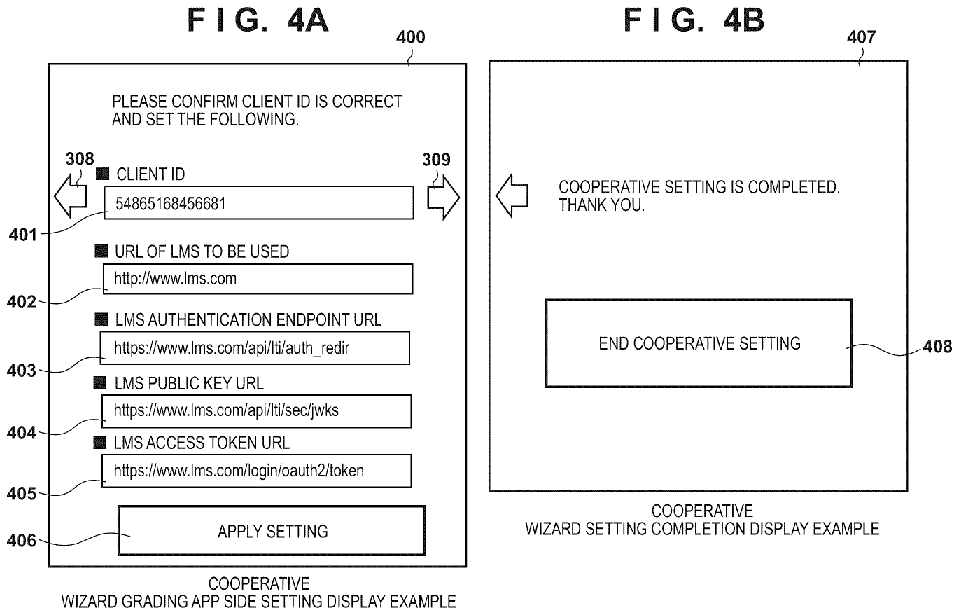

FIGS. 4A and 4B depict views illustrating examples of screens displayed on the information device 110 according to the embodiment.

A screen 400 of a cooperative wizard grading app side setting display example in FIG. 4A shows an example of a screen of a wizard for cooperating the grading app and the LMS, displayed by accessing the multi-function peripheral 100 via the communication unit 115 by the browser 112 of the information device 110. It is also possible to shoot the two-dimensional code 216 displayed on the screen 215 of the digital grading app LUI grading/aggregating page example 6 in FIG. 2H by the image capturing unit 113 of the information device 110 to access the multi-function peripheral 100. On this screen 400, it is possible to set various types of information 401 to 405 necessary for the grading app mounted on the multi-function peripheral 100 to perform authentication processing on the LMS.

A client ID 401 designates a client ID obtained from the LMS on the screen 326 of the cooperative wizard LMS side setting display example 8 in FIG. 3H and saved in the multi-function peripheral 100. A URL of the LMS used by the user is input as a URL 402 of the LMS of the cooperation target. In an LMS authentication endpoint URL 403, an authentication URL of the LMS of the cooperation target is input. The grading app accesses the URL 403 to perform authentication processing. As an LMS public key URL 404, a public key URL provided by the LMS of the cooperation target is input. This public key is used when the grading app verifies an authentication response received from the LMS. As an LMS access token URL 405, an access token obtaining URL provided by the LMS of the cooperation target is input. When a cooperative function such as Assignment and Grade Services is used, the URL 405 is accessed to obtain an access token, and then a processing request is made. The setting of these pieces of information 401 to 405 is completed and an “apply setting” button 406 is pressed, whereby LMS cooperation information can be set in the multi-function peripheral 100.

A screen 407 of a cooperative wizard setting completion display example in FIG. 4B shows an example of a screen displayed when the cooperative setting is completed. In the embodiment, the transition is made by pressing the “apply setting” button 406 on the screen 400 of the cooperative wizard grading app side setting display example in FIG. 4A. On this screen 407, an “end cooperative setting” button 408 is pressed, whereby the screen can transition to an arbitrary screen such as a top screen of the RUI of the multi-function peripheral 100.

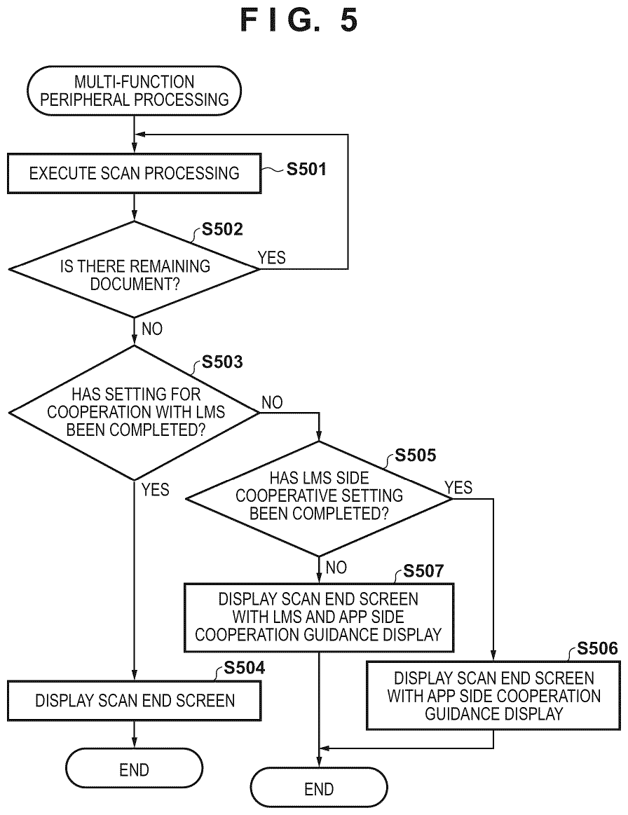

FIG. 5 is a flowchart for describing processing when the multi-function peripheral 100 according to the present embodiment executes scan processing for an answer sheet. By the processing shown in this flowchart, a series of control of the scan processing of the answer sheet and guidance display processing to LMS cooperation is executed. This embodiment describes processing performed on the screens of FIGS. 2E to 2H, which are screens when and after the start button 210 is pressed on the screen 209 of the digital grading app LUI grading/aggregating page example 2 in FIG. 2D. Note that the processing shown in this flowchart is implemented by the CPU 101 of the multi-function peripheral 100 executing a program deployed into the DRAM 103.

First, in step S501, upon receiving a scan execution instruction from the user, the CPU 101 performs scan processing using the scanner 105, and the processing advances the process to step S502. Note that the scan processing mentioned here is the same as scan processing performed by the general multi-function peripheral 100, and is implemented by a known means, and image data obtained by the scan processing is saved in the DRAM 103.

Next, the processing proceeds to step S502 and the CPU 101 determines whether all documents loaded in the scanner 105 have been read, and the processing proceeds to step S501 if there is a remaining document that has not been read and the processing proceeds to step S503 if there is no remaining document.

In step S503, the CPU 101 determines whether the cooperative setting for cooperation with the LMS has been completed. That is, with reference to grading app information in the ROM 102, it is confirmed whether the authentication information on the LMS is held or whether the cooperative setting on the grading app side is completed. Note that in the embodiment, the presence or absence of the client ID set on the screen 326 of the cooperative wizard LMS side setting display example 8 in FIG. 3H is confirmed as the authentication information on the LMS. Then, the presence or absence of various types of information set on the screen 400 of the cooperative wizard grading app side setting display example in FIG. 4A is confirmed as the cooperative setting on the grading app side. If those pieces of information exist, it is determined that the cooperative setting for cooperation with the LMS is completed, and the processing is advanced to step S504. Otherwise, the processing is advanced to step S505. In step S504, the CPU 101 displays the screen 212 of the digital grading app LUI grading/aggregating page example 4 illustrated in FIG. 2F, for example, which is a scan end screen, and ends this processing.

If the cooperative setting for cooperation with the LMS has not been completed, the CPU 101 determines in step S505 whether or not LMS side cooperative setting has been completed. That is, in the embodiment, the presence or absence of the client ID obtained from the LMS is confirmed. If the client ID exists, it is determined that the LMS side cooperative setting has been completed, and the processing proceeds to step S506 to prompt the cooperative setting on the app side. On the other hand, if the client ID does not exist, the processing proceeds to step S507 to prompt the cooperative setting of both the LMS and the app side. In step S506, the CPU 101 displays, for example, the screen 215 of the digital grading app LUI grading/aggregating page example 6 in FIG. 2H, that is, a scan end screen with app side cooperation guidance display, and ends this processing.

On the other hand, in step S507, the CPU 101 displays, for example, the screen 213 of the digital grading app LUI grading/aggregating page example 5 in FIG. 2G, that is, a scan end screen with LMS and app side cooperation guidance display, and ends this processing.

With this processing, for example, when scan processing that can cooperate with an external web service that provides LMS is executed, if cooperation with the web service is not set, a screen for guiding to a screen for setting the cooperation can be displayed depending on the content of the setting. Specifically, if the LMS side cooperative setting has been completed, the process is advanced to a process for prompting the setting on the app side, and if the LMS side cooperative setting has not been completed, the process is advanced to a process for prompting the cooperative setting on both the LMS side and the app side.

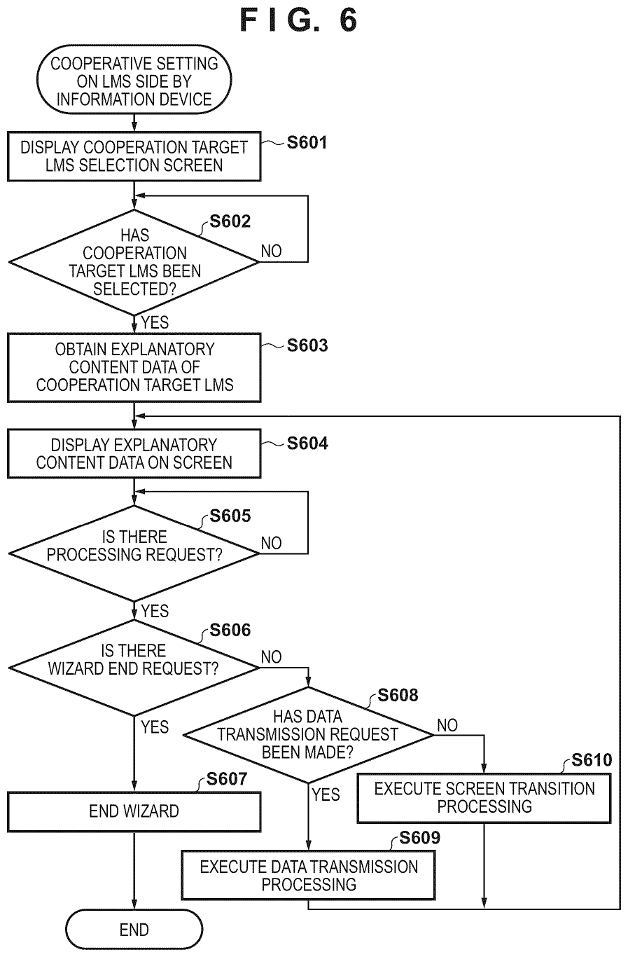

FIG. 6 is a flowchart for describing processing of performing cooperative wizard LMS side setting display by the information device 110 according to the embodiment. Executing the processing shown in this flowchart makes it possible to perform cooperative setting to the LMS side. In the embodiment, it is processing of displaying and executing the screen examples illustrated in FIGS. 3A to 3H. Note that the processing shown in this flowchart is implemented by the CPU 114 of the information device 110 deploying a program of the ROM 116 into the DRAM 117 and executing the program.

In step S601, the CPU 114 displays a cooperation target LMS selection screen obtained from the multi-function peripheral 100, and the processing proceeds to step S602. In the embodiment, it corresponds to display of the screen 300 of the cooperative wizard LMS side setting display example 1 in FIG. 3A. This screen is displayed by shooting and accessing the two-dimensional code 214 displayed on the screen 213 of the digital grading app LUI grading/aggregating page example 5 in FIG. 2G by the image capturing unit 113 of the information device 110.

Next, the processing proceeds to step S602, and the CPU 114 determines whether the LMS of the cooperation target is selected on the screen 300. Here, if it is determined that the LMS of the cooperation target is not selected, the processing remains in step S602 and waits for a user input. On the other hand, if the LMS of the cooperation target is selected, the processing proceeds to step S603. In step S603, the CPU 114 obtains, from the multi-function peripheral 100, explanatory content data of the cooperation target LMS selected by the user on the screen 300, and the processing proceeds to step S604. In step S604, the CPU 114 displays the explanatory content data obtained in step S603 on the operation unit 111, and the processing advances to step S605.

In step S605, the CPU 114 determines whether there is any processing request from the user. In the embodiment, a screen transition request by pressing of the back and forward buttons 308 and 309, a data transmission request by the save button 329, and the like are referred to. If there is no processing request, the processing remains in step S605 and waits for a user input. If there is a processing request, the processing proceeds to step S606. In step S606, the CPU 114 determines whether a wizard end request has been made. If the wizard end request has been made, the processing proceeds to step S607. If no end request has been made, the processing proceeds to step S608. In step S607, the CPU 114 transitions to another arbitrary screen, and ends this process. At this time, the transition destination may be the top page of the RUI provided by the multi-function peripheral 100 or the top page of the grading app.

On the other hand, in step S608, the CPU 114 determines whether a data transmission request has been made. In the embodiment, it refers to pressing of the save button 329 or pressing of an apply button. If the data transmission request is made, the processing proceeds to step S609. If no data transmission request has been made, it is determined as a screen transition request, and the processing proceeds to step S610. In step S609, the CPU 114 transmits requested data to the multi-function peripheral 100 via the communication unit 115, and the processing advances to step S604. In the embodiment, processing of transmitting the set client ID to the multi-function peripheral 100 or processing of transmitting information related to set LMS authentication to the multi-function peripheral 100 are meant. Upon receiving those pieces of information via the communication unit 107, the multi-function peripheral 100 saves them into the DRAM 103. In step S610, the CPU 114 confirms a transition request, performs screen transition processing as illustrated in FIGS. 3A to 3H such as returning and proceeding according to the transition request, and advances the process to step S604.

With this processing, the information device 110 can perform setting processing on the cooperative wizard LMS side and transmit the set client ID and information related to the set LMS authentication to the multi-function peripheral 100.

Note that in the multi-function peripheral 100, for example, if the screen prompting the cooperative setting of both the LMS and the app side is displayed in step S507 in FIG. 5 described above, the screen makes transition from that in FIG. 2G to that in FIG. 3A, and the cooperative setting on the LMS side is performed. Furthermore, the screen in FIG. 4A is displayed, and the cooperative setting on the app side is performed.

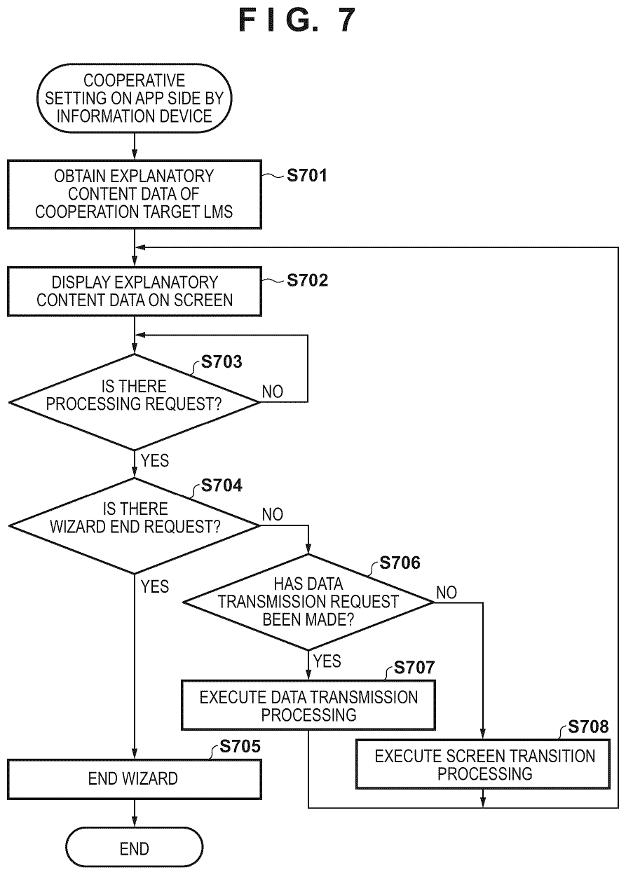

FIG. 7 is a flowchart for describing processing of performing setting display on a cooperative wizard grading app side by the information device 110 according to the embodiment. The processing shown in this flowchart makes it possible to perform the cooperative setting to the grading app side. In the embodiment, the processing is performed with the screen 400 of the cooperative wizard grading app side setting display example of FIG. 4A displayed.

In step S701, the CPU 114 reads the cooperative setting data saved in the ROM 102 of the multi-function peripheral 100, and obtains the LMS information on the cooperation target. Then, the explanatory content data of the LMS is obtained from the multi-function peripheral 100, and the processing proceeds to step S702.

In step S702, the CPU 114 displays the explanatory content data obtained in step S701 on the operation unit 111, and the processing proceeds to step S703. In step S703, the CPU 114 determines whether there is any processing request from the user. In the embodiment, a screen transition request by pressing of the back and forward buttons 308 and 309, a data transmission request by the save button 329, and the like are referred to. If there is no processing request, the process remains in step S703 and waits for a user input. If there is a processing request, the processing is advanced to step S704. In step S704, the CPU 114 determines whether a wizard end request has been made. If the wizard end request has been made, the processing proceeds to step S705. If no end request has been made, the processing proceeds to step S706. In step S705, the CPU 114 makes a transition to another arbitrary screen, and ends this process. At this time, the transition destination may be the top page of the RUI provided by the multi-function peripheral 100 or the top page of the grading app.

On the other hand, in step S706, the CPU 114 confirms whether a data transmission request has been made. In the embodiment, pressing of the save button 329 in FIG. 3H and pressing of the “apply setting” button 406 in FIG. 4A are referred to. If the data transmission request has been made, the processing proceeds to step S707, and if no data transmission request has been made, it is determined as a screen transition request, and the processing proceeds to step S708. In step S707, the CPU 114 transmits the requested data to the multi-function peripheral 100 via the communication unit 115, and the processing proceeds to step S702. In step S708, the CPU 114 confirms the transition request, performs screen transition processing such as returning and proceeding according to the transition request, and the processing proceeds to step S702.

With this processing, the information device 110 can perform setting processing on the cooperative wizard grading app side, transmit the information that is set, for example, as illustrated in FIG. 4A, to the multi-function peripheral 100, and perform setting on the cooperative wizard grading app side.

Note that in the embodiment, the URL indicated by the two-dimensional codes 214 and 216 in FIGS. 2G and 2H, for example, is changed according to the cooperation state. However, the present disclosure is not limited to this, and for example, the URL may be the same, and after the URL is displayed, the cooperation state of the multi-function peripheral 100 may be confirmed in processing in the URL and redirected to appropriate content.

In the embodiment, all cooperation with the LTI is performed manually. However, the present disclosure is not limited to this, and for example, the setting may be performed automatically using a setting file for an LMS into which the data describing the setting file can be imported.

When the setting on the LMS side is changed and issued LTI authentication information becomes unavailable, the information related to authentication of the grading app held in the multi-function peripheral 100 is deleted. Then, in the subsequent scan processing, guidance to setting of the cooperative wizard, for example, the screen 213 in FIG. 2G may be displayed.

Not only the close button but also a button indicating that cooperative setting is unnecessary may be displayed when the guidance of setting of the cooperative wizard is displayed, and if the button is pressed, the guidance to the setting of the cooperative wizard may not be displayed in the next or subsequent scan.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-101420, which was filed on Jun. 24, 2024, and which is hereby incorporated by reference herein in its entirety.

What is claimed is:

1. An information processing apparatus comprising:
one or more controllers including one or more processors and one or more memories, the one or more controllers configured to:
determine whether cooperative setting for cooperation with a digital service is completed when processing that can cooperate with the digital service is executed;
in a case that it is determined that cooperation with the digital service is not completed, determine whether setting information for the cooperation issued from the digital service is held;
in a case that it is determined that the setting information for the cooperation is not held, display a first screen for performing setting of cooperation with the digital service and setting of the processing that can cooperate with the digital service in the information processing apparatus; and
in a case that it is determined that the setting information for cooperation is held, display a second screen for performing setting of the processing that can cooperate with the digital service in the information processing apparatus.

2. The information processing apparatus according to claim 1, wherein the first screen includes a code for starting a wizard for performing setting of cooperation with the digital service and setting of the processing in the information processing apparatus, and
the second screen includes a code for starting a wizard for setting the processing in the information processing apparatus.

3. The information processing apparatus according to claim 1, wherein the setting information for cooperation with the digital service includes a client ID obtained by the information processing apparatus from the digital service with cooperative setting of the digital service.

4. The information processing apparatus according to claim 2, wherein the wizard is started by a device that provides the digital service.

5. The information processing apparatus according to claim 2, wherein the one or more controllers further receive, from a device that provides the digital service, information set with the device by the wizard.

6. The information processing apparatus according to claim 1, wherein the processing that can be cooperated with the digital service includes processing of reading an answer sheet, and the digital service includes grading and aggregating processing of the answer sheet.

7. The information processing apparatus according to claim 1, wherein the digital service includes grading and aggregating processing by a learning management system.

8. The information processing apparatus according to claim 6 further comprising:
a scanner that reads a document,
wherein the grading and aggregating processing is processing based on image data obtained by the scanner reading the answer sheet.

9. The information processing apparatus according to claim 8, wherein the one or more controllers execute, after the scanner reads the answer sheet, determination as to whether cooperative setting for cooperation with the digital service is completed and determination as to whether setting information for cooperation is held.

10. A method of controlling an information processing apparatus, comprising:
determining whether cooperative setting for cooperation with a digital service is completed when processing that can cooperate with the digital service is executed;
in a case that it is determined that cooperation with the digital service is not completed, determining whether setting information for cooperation with the digital service issued from the digital service is held;
in a case that it is determined that the setting information for cooperation with the digital service is not held, displaying a first screen for performing setting of cooperation with the digital service and setting of the processing in the information processing apparatus; and
in a case that that the setting information for cooperation with the digital service is held, displaying a second screen for performing setting of the processing in the information processing apparatus.

11. A non-transitory computer-readable storage medium storing a program for causing a processor to execute a method of controlling an information processing apparatus, the method comprising:
determining whether cooperative setting for cooperation with a digital service is completed when processing that can cooperate with the digital service is executed;
in a case that it is determined that cooperation with the digital service is not completed, determining whether setting information for cooperation with the digital service issued from the digital service is held;
in a case that it is determined that the setting information for cooperation with the digital service is not held, displaying a first screen for performing setting of cooperation with the digital service and setting of the processing in the information processing apparatus; and
in a case that that the setting information for cooperation with the digital service is held, displaying a second screen for performing setting of the processing in the information processing apparatus.
